(19) United States
(12) Patent Application Publication
(10) Pub. No.: US 2009/0037426 A1
(43) Pub. Date: Feb. 5, 2009

(54) COMPUTER-IMPLEMENTED SYSTEM AND METHOD FOR AGGREGATING AND SELECTIVELY DISTRIBUTING CRITICAL PERSONAL INFORMATION TO ONE OR MORE USER-DESIGNATED RECIPIENTS

(76) Inventor: Samuel S. Haviland, JR., Fairfield, CT (US)

Correspondence Address: PILLSBURY WINTHROP SHAW PITTMAN, LLP, P.O. BOX 10500, MCLEAN, VA, 22102, US

(21) Appl. No.: 11/832,326

(22) Filed: Aug. 1, 2007

(51) Int. Cl. G06F 17/30; G06F 3/14

(52) U.S. Cl. 707/10; 715/762

(57) ABSTRACT

The invention relates to systems and method for aggregating and selectively distributing information useful after or during a critical life event. The invention includes receiving critical personal information from a user, wherein the critical personal information is useful to handle the affairs of the user when the user is deceased or otherwise unavailable. The user then designates one or more recipients to receive part or all of the critical personal information. For each designated recipient, an encrypted file may be created that includes a specifically designated set of part or all of the critical personal information. The encrypted files may then be sent to their respective recipients. Each recipient may then acquire a client-side viewer module that enables viewing of the critical personal information on encrypted file on a computer-implemented device.

### FIELD OF THE INVENTION

The invention relates to computer-implemented systems and methods including a computer software application that enables a user to aggregate and selectively distribute critical personal information to one or more user-designated recipients.

### BACKGROUND OF THE INVENTION

Approximately three million people die in the U.S. every year, and many more are injured, incapacitated or encounter circumstances requiring serious emergency aid. Many of these people have critical personal information that may be needed by others around them in order to deal with such death, injury, incapacity or other emergency circumstances. As used herein, “critical personal information” can include information about the existence and/or location of documents, things, accounts, people and/or other critical personal information. This information may be recorded in documents, some of which are legally enforceable. It may also be in the possession of a person's family members, advisors, medical or legal or financial professionals or others. It may also be in a locked safe or safe deposit box among other locations.

Relatives, friends, professionals and other persons responsible for handling matters in instances of a person's death, injury, incapacity or in emergency circumstances typically must scramble to assemble all of the necessary legal and practical information relating to the person's affairs. For example, the existence and/or location of a power of attorney, will or other document may not be known by the appropriate people at the appropriate time. Furthermore, the location of practical items such as house keys, safe deposit box keys, or other items may not be known by the appropriate people at the appropriate time. The existence or identity of bank accounts, investment accounts, or other financial information may also not be known by the appropriate person at the appropriate time. Additionally, the identity of important people, such as doctors, lawyers, executors, or other information may not be known by the appropriate people at the appropriate time.

Thus, in connection with a “critical life event” (or at other times) the appropriate people may need access to “critical personal information” of another. As used herein the term “critical life event” refers to any situation wherein the critical personal information of a person is needed by others. For example, a critical life event may include the death of a person, the incapacitation of a person (e.g., the person is hospitalized and is unable to communicate), the unavailability of a person (e.g., the person goes “missing”), the occurrence of a mass emergency (e.g., a natural disaster, a catastrophe, a terrorist attack, or other mass emergency) affecting the person, or other occurrences wherein others need the critical personal information of the person.

This lack of information not only affects those left behind when a person dies, but also affects persons who must make decisions when a person becomes permanently or temporarily incapacitated and is unable to make health care decisions, financial decisions, or other decisions, such as in case of emergency.

Prior attempts have been made to address some of these problems. Typically, these systems have shortcomings. For example, some attempts involve complex systems that require the uploading of documents to a Website. This is disadvantageous, because some people do not have the documents electronically and/or will not want to scan documents for this purpose. Additionally, the need to store these personal documents on a third party website/server creates issues of trust and security that may discourage some people from using such a system.

Providing access to such highly sensitive personal information may pose other problems if it is not done in a controlled and secure manner. Other drawbacks exist with web-based systems that require some central storage of documents.

These and other drawbacks exist with known systems.

### SUMMARY OF THE INVENTION

One aspect of the invention relates to a computer-implemented system including a computer software application that enables a user to aggregate and selectively distribute critical personal information to one or more user-designated recipients. The software may: i) enable a user to enter items of critical personal information; ii) enable a user to designate recipients for some or all of the critical personal information on an item-by-item basis; iii) encrypt the critical personal information; and iv) transmit the relevant critical personal information to the designated recipient(s). According to one embodiment, a communication relating to the critical personal information is sent directly by the computer software to the one or more designated recipients. An advantage of this aspect of this embodiment of the invention is that actual documents (or other items) need not be centrally stored (e.g., on a third party website or other server). Rather, an identification of the existence and location of items can be distributed.

In some embodiments, the communication to the one or more designated recipients may include encrypted personal critical information. The encryption may be such that the recipient needs a special viewer application to view the received critical personal information. According to one embodiment of the invention, the viewer application may be downloaded (or otherwise obtained) from a suitable location and used to view the critical personal information received.

In some embodiments, the critical personal information is sent from a user to a recipient, rather than being made accessible from a central location. This peer to peer transfer may provide additional protection against unauthorized access. The fact that critical personal information sent to the designated recipient may be encrypted and may only be accessed by a specific viewer also provides protection against unauthorized access to the critical personal information. In some embodiments, designated recipients may need a password, which may be sent in a separate communication (e.g., from the remote site, from the user, or obtained elsewhere) to download the viewer. In these instances, even more protection is provided against unauthorized access to the critical personal information. As such, the system may include multiple layers of security, control, and protection from unauthorized access.

According to one embodiment, the viewer is a copy of the computer software application with certain functionality disabled. For example, the viewer may be a version of the computer-implemented application wherein only viewing/saving of the encrypted files is enabled. If desired, the recipient may enable the disabled functionality by obtaining a license or otherwise unclocking the disabled functionality. In this way, recipients can then use the computer software application to aggregate and distribute their own critical personal information, thus providing a viral marketing component to this implementation.

In some embodiments, the critical personal information received by the computer-implemented application from the user may be encrypted or otherwise securely stored so that only the user has access to the critical personal information unless and until the user designates one or more recipients to receive some or all of the critical personal information. The user may designate one or more recipients to receive access to some or all of the critical personal information on an item by item basis. In some embodiments, one or more communications may be sent to the designated recipients, enabling the recipients to access their selected portion of the critical personal information. Thus, the recipient will have access to the critical personal information for use upon the occurrence of a critical life event. In some embodiments, one or more of the communications may include a personalized message.

In some embodiments, the invention may include a computer-implemented application having one or more modules for performing some or all of the above features and functions (and/or other features and functions, if desired).

In some embodiments, the invention may include a computer readable medium having thereon computer readable code for instructing one or more processors to perform any or all of the features and functions of invention described herein.

These and other objects, features, and advantages of the invention will be apparent through the detailed description and the drawings attached hereto. It is also to be understood that both the foregoing summary and the following detailed description are exemplary and not restrictive of the scope of the invention.

### BRIEF DESCRIPTION OF THE DRAWINGS

FIG. 1 illustrates an example of a system for aggregating and securely and selectively distributing critical personal information to one or more user-designated recipients, according to various embodiments of the invention.

FIGS. 2A and 2B illustrate an example of a process for guided aggregation and secure, selective distribution of critical personal information according to various embodiments of the invention.

FIG. 3 illustrates an example of a user interface that receives user account information according to various embodiments of the invention.

FIG. 4 illustrates an example of a user interface for selecting a user profile according to various embodiments of the invention.

FIG. 5 illustrates an example of a user interface that receives critical personal information regarding friends/family according to various embodiments of the invention.

FIG. 6 illustrates an example of a user interface that receives critical personal information regarding medical information according to various embodiments of the invention.

FIG. 7 illustrates an example of a user interface that receives critical personal information regarding legal information according to various embodiments of the invention.

FIG. 8 illustrates an example of a user interface that receives critical personal information regarding insurance/benefits according to various embodiments of the invention.

FIG. 9 illustrates an example of a user interface that receives critical personal information regarding financial information according to various embodiments of the invention.

FIG. 10 illustrates an example of a user interface that receives critical personal information regarding notification/burial wishes according to various embodiments of the invention.

FIG. 11 illustrates an example of a user interface that receives critical personal information regarding logistics or other personal critical information according to various embodiments of the invention.

FIG. 12 illustrates an example of a user interface that receives critical personal information relating to notes/comments or other personal critical information according to various embodiments of the invention.

FIG. 13 illustrates an example of a user interface for designating recipients from a list of available recipients according to various embodiments of the invention.

FIG. 14 illustrates an example of a user interface for selecting critical personal information available to a particular recipient and constructing a message to accompany personal critical information, according to various embodiments of the invention.

FIG. 15 illustrates an example of a user interface for previewing outbound communications to selected designated recipients and causing distribution of critical personal information according to various embodiments of the invention.

### DETAILED DESCRIPTION

The invention relates to a system and method for aggregating and selectively distributing critical personal information to one or more user-designated recipients. In some embodiments, the system and method of the invention may utilize a computer software application that receives “critical personal information,” from a user. In some embodiments, the computer software application may encrypt and/or otherwise securely store the received personal critical information on a user computer, whereupon the user may add to or update the critical personal information. The computer software application may enable the user to designate one or more recipients to receive access to some or all of the critical personal information on an item-by-item basis. The designated recipients may receive one or more communications enabling access to some or all of the user's critical personal information. The one or more recipients may utilize their selected portion of the critical personal information to handle the affairs of the user during a or after critical life event of the user. In some embodiments, the one or more recipients may utilize a viewer application to view the encrypted personal critical information of the user. In some embodiments, the viewer application may be a version of the computer software application with one or more features disabled, such that the recipient can only view and/or securely store the user's personal critical information. Other viewers (proprietary or otherwise) may be used. In some embodiments, the recipient may enable the one or more disabled features of the computer software application by, for example, obtaining a license for the application and using a license key to unlock or enable the functionality in a generally known manner, whereupon the recipient may aggregate and selectively distribute their own critical personal information. Other techniques for enabling the disabled functionality may be used.

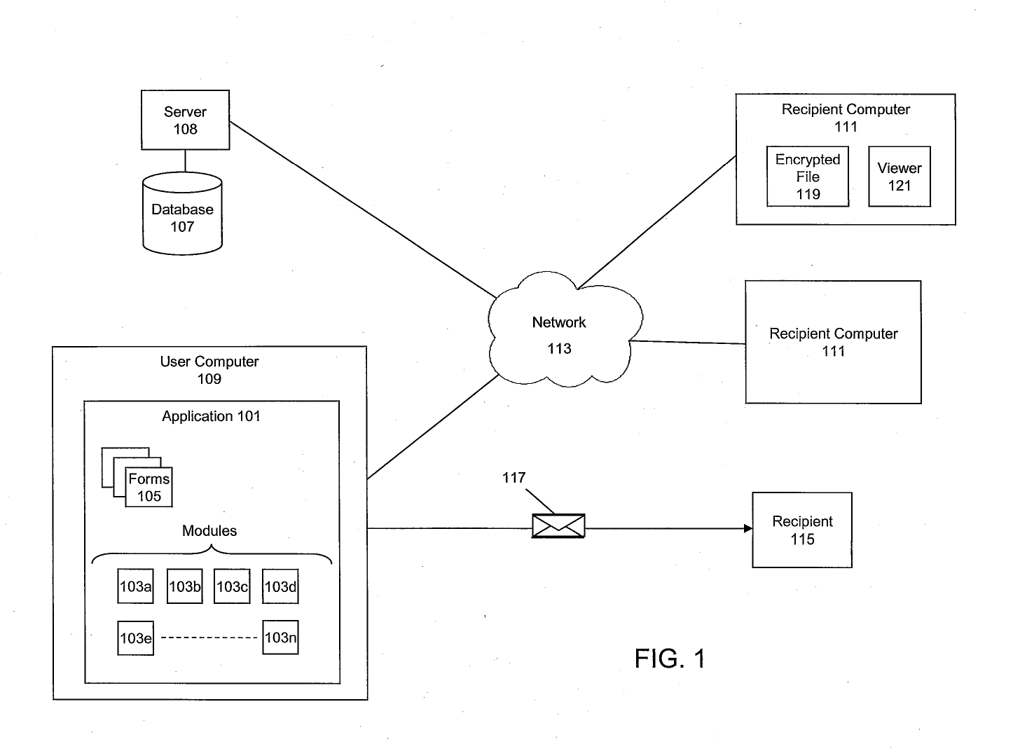

FIG. 1 illustrates a computer software application 101, which is an example of a computer software application for aggregation and selective distribution of critical personal information according to various embodiments of the invention. Computer software application 101 may include one or more modules 103a-103n, one or more forms 105, and/or other elements. In some embodiments, application 101 may utilize and/or interact with a database 107, a server 107, and/or other elements. In some embodiments, application 101 may exchange data with or otherwise communicate with one or more user computers 109 and one or more recipient computers 111, via network 113 or via other methods.

In some embodiments, application 101 may comprise a software application accessed by, loaded on, and/or run on user computer 109. In some embodiments, application 101 may be loaded onto user computer 109 via a disk, portable memory device or other computer readable medium, may be downloaded onto user computer 109 via a network 113 (which may be or include, for example, the Internet) from server 108 or from another source, or may otherwise be loaded onto user computer 109. In some embodiments, application 101 may be run from an Internet web site or other host site or computer application maintained on a server (e.g., server 108) by a service provider or other entity.

Application 101 may comprise one or more modules 103a-n for receiving account information regarding a user, receiving critical personal information, updating critical personal information, receiving recipient-related information, and/or for receiving other information from one or more users. One or more modules 103a-n may also enable encryption of critical personal information, transmittal of critical personal information or other information via outbound communications to recipients (including the transmittal of encrypted files comprising critical personal information), transmittal of viewers for reading encrypted files to recipients, viewing of encrypted critical personal information, and/or other features and functions.

In particular, application 101 may include a data reception module 103a, a user account module 103b, an encryption module 103c, a communication module 103d, a rules module 103e, and/or other modules. One or more of modules 103a-103n comprising application 101 may be combined. For some purposes, not all modules may be necessary.

Application 101 may also include one or more forms 105 which may be used to elicit information from one or more users 109. Information elicited from one or more forms 105 may include user account information, critical personal information, information relating to recipients of critical personal information, information related to communications sent by or initiated by application 101, and/or other information.

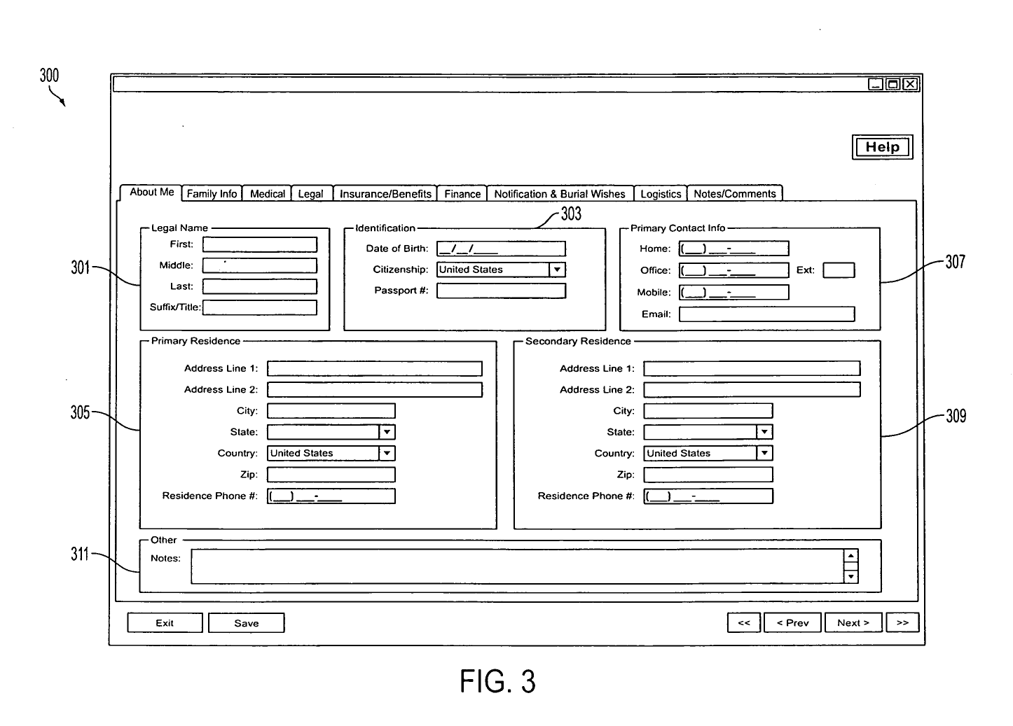

In some embodiments, the one or more forms 105 may include electronic forms. Electronic forms may include one or more graphical user interfaces (GUIs) presented to users (e.g., via user computer 109) by application 101 (see, for example, FIGS. 3-15). In some embodiments, a data reception module 103a or other module of application 101 may support the presentation of one or more GUIs/forms 105 to users via user computers 109 and the reception of information (account information, personal critical information, recipient-related information and/or other information) therefrom. Users may access the GUIs/forms 105 via network 113 (which may include, for example, the Internet).

As described herein, in some embodiments, part or all of application 101 may run on, be stored on, and/or interface with user computer 109. In some embodiments, application 101 may be downloaded from a remote site (e.g., server 108) to user computer 109 via network 113. Application 101 or portions thereof may also be transferred to user computer 109 via a disk, non-volatile memory (e.g., memory stick), or by other methods. To the extent that local storage (e.g., memory on user computer 109) or other local functionality of user computer 109 is needed for use by the systems and methods of the invention, then such storage may be accessed by application 101. In some embodiments, application 101, if stored on user computer 109 may be updated via network 113 or via other methods as necessary/appropriate.

The configuration illustrated in FIG. 1 is exemplary only. Those having ordinary skill in the art will appreciate that the system of the invention may have various configurations that include less or more of the elements illustrated in FIG. 1, including configurations wherein one or more elements of application 101 run on, are stored on, and/or otherwise utilize database 107, server 108, and/or other additional computer-implemented hardware or software.

As described herein, application 101 may run on and/or otherwise interface with one or more users via one or more user computers 109. A user may include a person for whom user critical personal information or other information is to be aggregated and selectively distributed to recipients. A user may utilize a user computer 109 to view GUIs/forms 105 or other graphical user interfaces supported by application 101, to provide information to application 101 (e.g. via entering information into forms 105), and/or to otherwise exchange data with, interact and/or instruct application 101. A user computer 109 may include any one or more wired or wireless computing devices such as, for example, a desktop computer, a laptop computer, mobile computing device, a handheld computing device, a personal digital assistant, a cell phone, a smart phone, or other computer-implemented device. In some embodiments, user computer 109 need not be a computing device owned by a user, but may be any computing device used by the user to access and/or interact with application 101 (e.g., a public computer).

As described herein, application 101 may also exchange data with or otherwise communicate with one or more recipients via recipient computers 111. A recipient may include a person who has been designated to receive or otherwise have access to certain critical personal information by a user. As such, a recipient may also be referred to herein as a “designated recipient.” In some embodiments, recipients may include or utilize one or more recipient computers 111 to access critical personal information or otherwise interact with application 101. A recipient computer 111 may include one or more wired or wireless computing devices such as, for example, desktop computers, laptop computers, mobile computing devices, handheld computers, personal digital assistants, cell phones, smart phones, or other computing devices. In some embodiments, recipient computer 111 need not be a computing device owned by a recipient, but may be any computing device used by the recipient to access critical personal information and/or otherwise interact with application 101 (e.g., a public computer).

In some embodiments, user account information, critical personal information, recipient-related information, and/or other information used by the systems and methods of the invention may be stored, in encrypted or non-encrypted form, on user computer 109, recipient computer 111, or on other computer systems as necessary. However, in some embodiments, application 101 may access and/or interface with database 107, which may store information used by the invention. Database 107 may store encrypted information and/or non-encrypted information, as necessary or desired. According to an embodiment of the invention, database 107 may be, include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Language Query), a SAN (storage area network), Microsoft Access™ or others may also be used, incorporated, or accessed into the invention. Database 107 may include any combination of databases or other data storage devices. In some embodiments, database 107 may reside on or otherwise be associated with a computer system (e.g., server 108) maintained by a service provider providing access to the systems and methods of the invention.

In some embodiments, user computers 109 or recipient computers 111 may interface with server 108, for example, for the purpose of downloading application 101 or portions thereof, transmitting account information (including payment information) to a service provider operating or otherwise associated with server 108, and/or for other purposes. Server 108 may include one or more computer-implemented devices having one or more processors and associated memory. As such, server 108 may include one or more distributed server machines, desktop computers, laptop computers, memory devices, or other computing devices or elements.

In some embodiments, user computers 109, recipient computers 111, database 107, and/or server 108, may exchange data via network 113. Network 113 may include any one or more of, for instance, the Internet, an intranet, a PAN (Personal Area Network), a LAN (Local Area Network), a WAN (Wide Area Network), a SAN (Storage Area Network), or a MAN (Metropolitan Area Network). Any suitable communications link may be utilized, including any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, a wireless data connection, or other connection.

In some embodiments, users and/or recipients may communicate with application 101 without using network 113. For example, in some embodiments, a recipient 115 may receive communications relating to the systems or methods of the invention in a non-electronic form such as, for example, in a registered letter or other letter 117 sent via traditional mail or package delivery service. These communications may originate from application 101, server 108, a service provider providing access to the systems and methods of the invention, or other source.

While application 101, modules 103a-103n, and forms 105 are illustrated in FIG. 1 as residing on user computer 109, in some embodiments, at least part of application 101 or other elements of the system of the invention may be stored on, run on, and/or interface with server 108. For example, application 101, one or more of modules 103a-103n or portions thereof and/or forms 105 or portions thereof may be hosed by server 108 and may be accessible to user computers 109 through a website or other portal via network 113.

Those having skill in the art will appreciate that the invention described herein may work with various configurations. Accordingly, more or less of the aforementioned components may be used and/or combined in various embodiments. It should also be understood that various software modules 103a-103n that are utilized to accomplish the functionalities described herein may be maintained on one or more of server 108, user computer 109, recipient computer 111, or other computer-implemented components, as necessary. In some embodiments, as would be appreciated, the functionalities described herein may be implemented in various combinations of hardware and/or firmware, in addition to, or instead of, software.

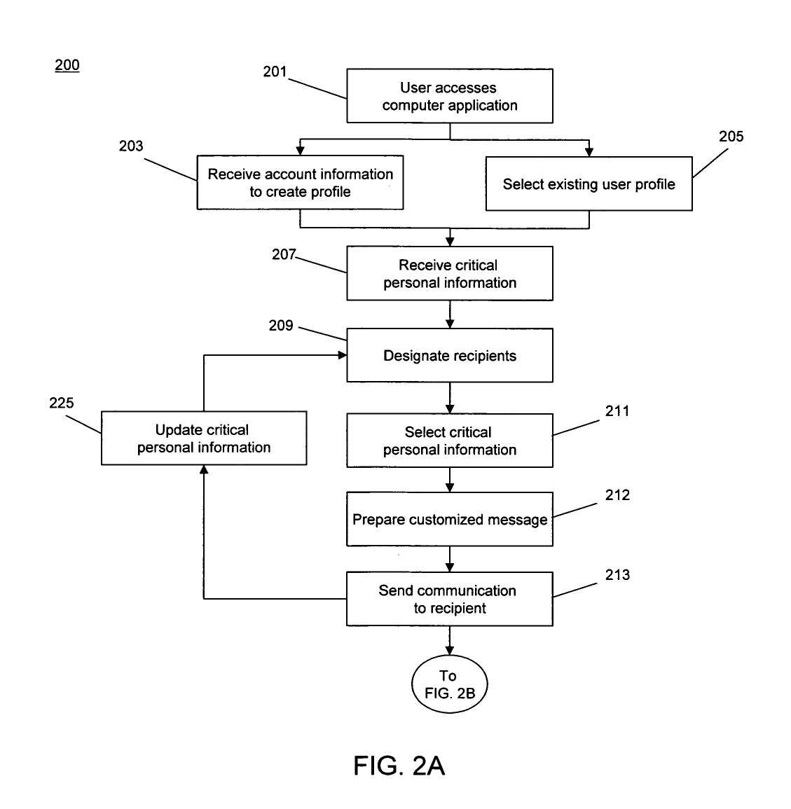

FIGS. 2A and 2B illustrates a process 200, which is an example of a process for aggregating and selectively distributing critical personal information to one or more user-designated recipients. In an operation 201, a user may access application 101. In some embodiments, individuals other than the user may access application 101 for the user or assist the user with access of or interaction with application 101. For example, a child, friend, relative, or professional advisor of the user may assist the user with accessing and entering information into application 101 or may access application 101 by proxy.

In some embodiments, the user may utilize user computer 109 to access application 101 as described herein. In some embodiments, application 101 may run from user computer 109. In some embodiments, accessing application 101 may include the user downloading application 101 and/or other elements of system 101 to user computer 109. In some embodiments, application 101 may run from a remote site (e.g., server 108) and may be accessed by the user via user computer 109 and network 113. In some embodiments, accessing application 101 may include the user connecting user computer 109 to the remote site and interacting with application 101 and/or via network 113.

In some embodiments, the user may only download or otherwise access application 101 until after the user has acquired a license to application 101 (e.g., by payment of a fee). In some embodiments, acquisition of a license or transmittal of payment information may occur after the user has downloaded or begun interaction with application 101.

In an operation 203, the user may provide, and application 101 may receive, user account information. In some embodiments, the user may provide user account information to application 101 using one or more forms 105. In some embodiments, user account information may be received by application 101 and stored locally on user computer 109. In some embodiments, the user account information may be transmitted to server 108 (e.g., via network 113) and stored in database 107 for the purposes of establishing an account for the user with a service provider of the systems and methods of the invention. Accounts established with such a service provider may enable the service provider to keep track of its customers and, in some embodiments, their personal critical information, receive payment for licenses to software application 101, provide updates and other information to users, and/or for other purposes.

In some embodiments, application 101 may receive user account information from the user via other methods such as, for example, forms 105 may be transmitted to the user from server 108 (or from a service provider) and to server 108 (or to the service provider, who may ultimately enter the information into database 107/server 108) from the user via email, fax, traditional mail, or other communication method.

In some embodiments, user account information may include one or more of a user's name, date of birth, country of citizenship, passport number, home phone number, office phone number, mobile phone number, email address, primary residence address, secondary residence address, and/or other information. FIG. 3 illustrates an interface 300 which is an example of a form 105 for receiving user account information according to various embodiments of the invention. Interface 300 may include regions 301-311 having fields therein for receiving user account information.

In some embodiments, user account information may include or be associated with payment information for the user. For example, as described herein, users may pay a service provider providing access to the systems and methods of the invention to acquire a license to application 101. As such, the user may provide the service provider (e.g., via application 101) with payment information (e.g., a credit card number, online payment account number—e.g., Paypal™—or other payment information) when providing other user account information.

In some embodiments, user account module 103b or other module of application 101 may enable receipt, storage, and any desired or necessary transmittal of user account information. In some embodiments, user account module 103b or other module of application 101 may associate the critical personal information received by application 101 regarding a specific user with that user's user account information. In some embodiments, part or all of a user's user account information may be considered or used as critical personal information such that user account information (e.g., name, address, or other user account information) is made available to one or more recipients.

If a user account already exists for the user, the user may select the account or “user profile” from a list of one or more user profiles to which the user has access in an operation 205. As used herein, the term “user profile” may refer to all information associated with a specific user (e.g., user account information, critical personal information, recipient-related information, or other information) or a subset thereof. In some instances, a first user may have access to multiple user profiles because other users have listed the first user as a recipient and transmitted their profiles to the first user. For example, the first user may be a professional (e.g., doctor, attorney, tax professional or other professional) or other person to whom multiple clients, associates, or friends send some or all of their personal critical information for use during or after a critical life event. As described herein, in some embodiments, application 101 may act as a viewer for critical personal information of others. As such, the first user may be able to select from various profiles of personal critical information of other users, as well as the first user's own profile. In some embodiments, the first user may not be able to modify the profiles of other users (e.g., the profiles of other users may be password protected), but may be able to add to or modify their own user profile (e.g., by providing application 101 with a proper password). When the first user desires to add to and or otherwise modify their own user profile, the user may select their profile from a list of one or more available user profiles.

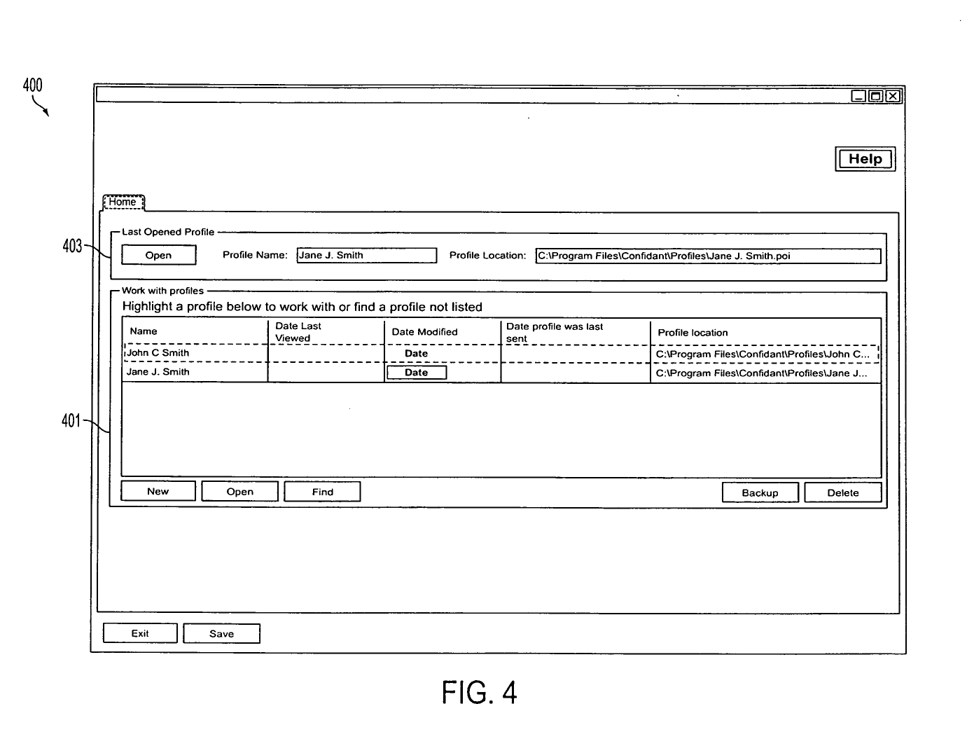

FIG. 4 illustrates an interface 400, which is an example of a form 105 providing an interface for displaying and selecting from existing user profiles. In some embodiments, interface 400 may include a region 401 wherein one or more user profiles are listed along with information relating to the listed profiles (e.g., the name of a user associated with a profile, a date a profile was last viewed, a date a profile was last modified, a date a profile was last sent to one or more recipients, a file pathname or other location indicator relating to where a the profile is stored, and/or other information), and wherein a user may select a profile from the one or more user profiles. In some embodiments, interface 400 may include a region 403 wherein the user may indicate that the selected profile is to be accessed. In some embodiments, each user profile may be password protected or otherwise protected so that unauthorized users cannot access and/or modify a previously existing user profile or any associated critical personal information.

In an operation 207, once a user profile is created and/or selected, the user may provide and application 101 may receive “critical personal information.” In some embodiments, the user may provide critical personal information to application 101 using one or more forms 105. In some embodiments, one or more forms 105 may be loaded onto user computer 109 when application 101 is loaded thereon. The user may access these forms 105 and provide personal critical information to application 101 by entering items of personal information into one or more fields of the one or more forms 105.

As discussed herein, in some embodiments, the completed forms 105 and the personal critical information contained thereon may be stored locally on user computer 109. However, in some embodiments, critical personal information may be stored at a remote site (e.g., server 108/database 107), completed forms 105 may be transmitted to and stored at the remote site via network 113. In some embodiments, other communication methods between the computer system of user 109 and the remote site may be used such as, for example, email, fax, traditional mail, or other communication method.

In some embodiments, rules module 103e or other module of application 101 may include one or more rules that determine the minimum user account information and/or critical personal information that the user must provide to application 101 for the user to utilize application 101. The minimum information may be set such that the critical personal information provided to recipients is useful for at least a minimum of one or more purposes. In one embodiment, the minimum information required may be the user account information (e.g., the information gathered via interface 300). In some embodiments, other standards may be set for minimum information. In some embodiments no minimum information level may be used.

In some embodiments, critical personal information may include information related to family members (e.g., parents, siblings, children, or other kin), friends, acquaintances, neighbors, pets, and/or confidants of the user (collectively referred to herein as “friend/family information”). In some embodiments, application 101 may enable the user to create separate “entries” for different friends or family. Each entry may be associated with information related to a specific person such as, for example, name, relationship to the user, address, phone numbers, email addresses, other contact information, or other information. Application 101 may enable the user to create, save, update, or delete entries as desired.

In some embodiments, friend/family related information may include the ages of any children or other family members of the user. In some embodiment, friend/family information may also include contact information regarding the school, daycare, college, or workplace of any children or other family members of user 109. In some embodiments, friend/family information may include a narrative or portion of text (e.g., a comments section) relating to a family member, friend, confidant, or other person. This narrative or portion of text may be associated with the specific entry of a specific family member, friend, acquaintances, neighbor, confidant, or other person. In some embodiments, the narrative or portion of text may serve to provide additional information relating to a family member, friend, or other person (e.g., info that does not fit into one of the specifically enumerated categories of the forms). In some embodiments, friend/family information may also include information related to one or more pets.

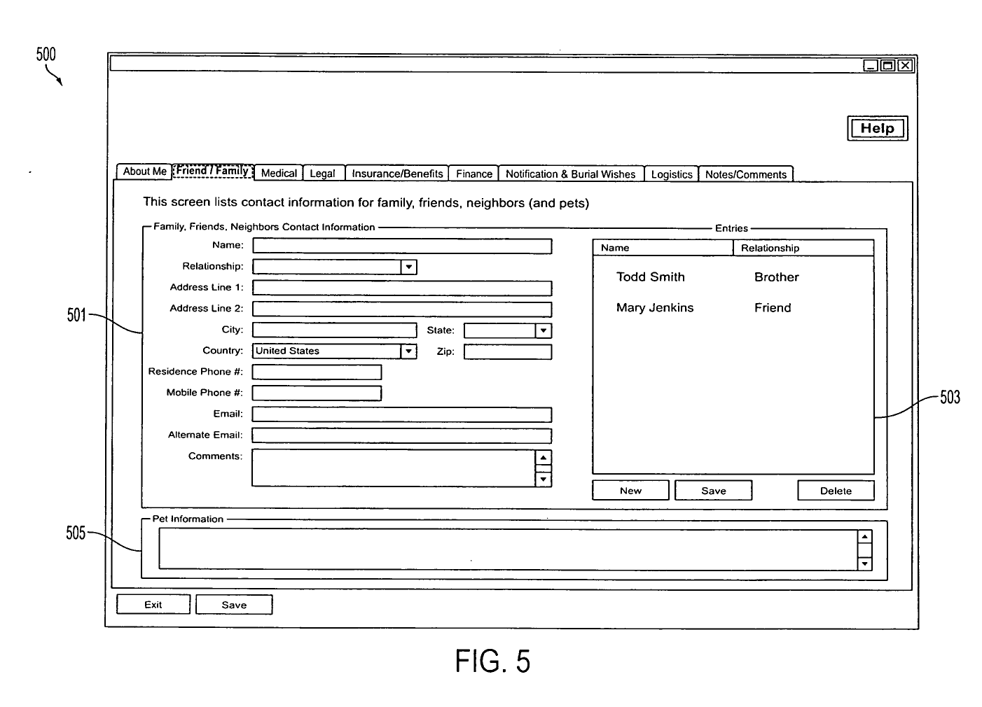

FIG. 5 illustrates an interface 500, which is an example of a form 105 that receives friend/family information from a user according to various embodiments of the invention. In some embodiments, interface 500 may include a region 501 having fields, whereby friend/family information may be entered into application 101. Interface 500 enables creation of one or more entries, each entry corresponding to a family member, friend, acquaintance, neighbor, confidant, or other person, and each being associated with information relating to the corresponding family member, friend, confidant, or other person. Interface 500 may include a region 503 wherein entries regarding friends/family and information relating to those entries (e.g., relationship to the user) may be listed, and selected for editing or deletion. Interface 500 may also include a region 505, wherein information regarding pets may be entered into application 101.

In some embodiments, critical personal information received by application 101 may include medical information. Medical information may include the locations of one or more medical documents such as, for example, a medical power of attorney document (or “durable Power of Attorney”), a living will document, an organ donor card or instructions, an advanced health care directive document, medical records, dental records, or other documents. In some embodiments, medical information may include information related to insurance of the user (e.g., medical/health insurance or other insurance) such as, for example, provider information, contact information, policy numbers, and/or other information. In some embodiments, medical information may include information relating to medical care personnel such as, for example, doctors, dentists, nurses, hospice contacts, or other medical care personnel.

In some embodiments, one or more entries may be created for medical personnel or other persons of medical relevance whose information is stored by application 101. The information relating to medical personnel stored in an entry may include a name, a description of their medical relevance to the user (or other description relating to their medical background), a phone number, an address, an email address, other contact information, a narrative or other portion of text (e.g., a comments section), or other information. The entries may be created, saved, updated, or deleted by the user, as desired.

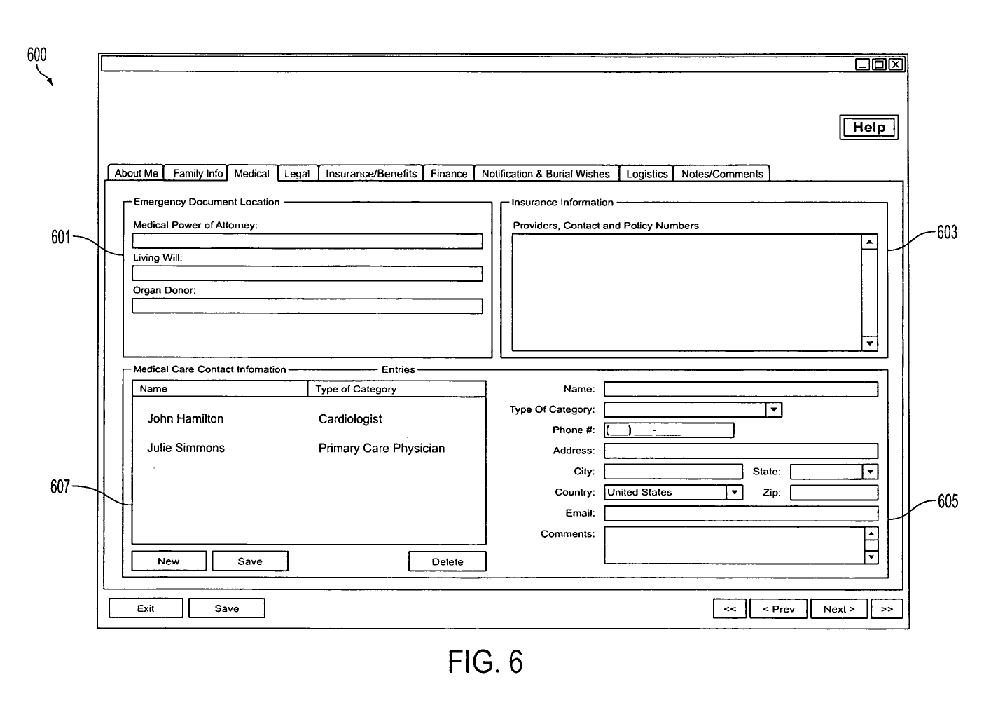

FIG. 6 illustrates an interface 600, which is an example of a form 105 enabling receipt of medical information regarding the user according to various embodiments of the invention. Interface 600 may include a region 601 having fields, whereby emergency or medically-related document location information may be entered by the user. Interface 600 may also include a region 603 having fields, whereby insurance-related information may be entered by the user. Interface 600 also enables creation of one or more entries, each entry corresponding to a medical care individual and each being associated with information relating to the corresponding medical care individual. Accordingly, interface 600 may include a region 605 having fields, whereby information relating to medically relevant persons may be entered and used to create entries. Interface 600 may include a region 607, wherein entries regarding medically-relevant persons and information relating to those entries (e.g., type or category of medical relevance) may be listed, and selected for editing or deletion.

In some embodiments, critical personal information provided by the user and received by application 101 may include legal information. Legal information may include an indication of the existence of and/or the location of one or more legal documents such as, for example, a power of attorney document, a last will and testament, deeds and/or title to real or personal property, a trust document, a medical power of attorney document, a living will document, an organ donor card or organ donor instructions, an advanced health care directive document, or other documents.

In some embodiments, legal information may include information relating to one or more persons relevant to a legal document such as, for example, the executor of a last will and testament, the name of a guardian for a child or other family member, the name of an individual granted power of attorney (medical or otherwise), the name of a trustee or beneficiary, or other person of legal relevance. In some embodiments, legally related information may include contact information for an attorney or other person of legal relevance. This contact information may include a name, a firm or organization name, a home phone number, an address, an email address, or other contact information. In some embodiments, entries may be created for persons of legal relevance.

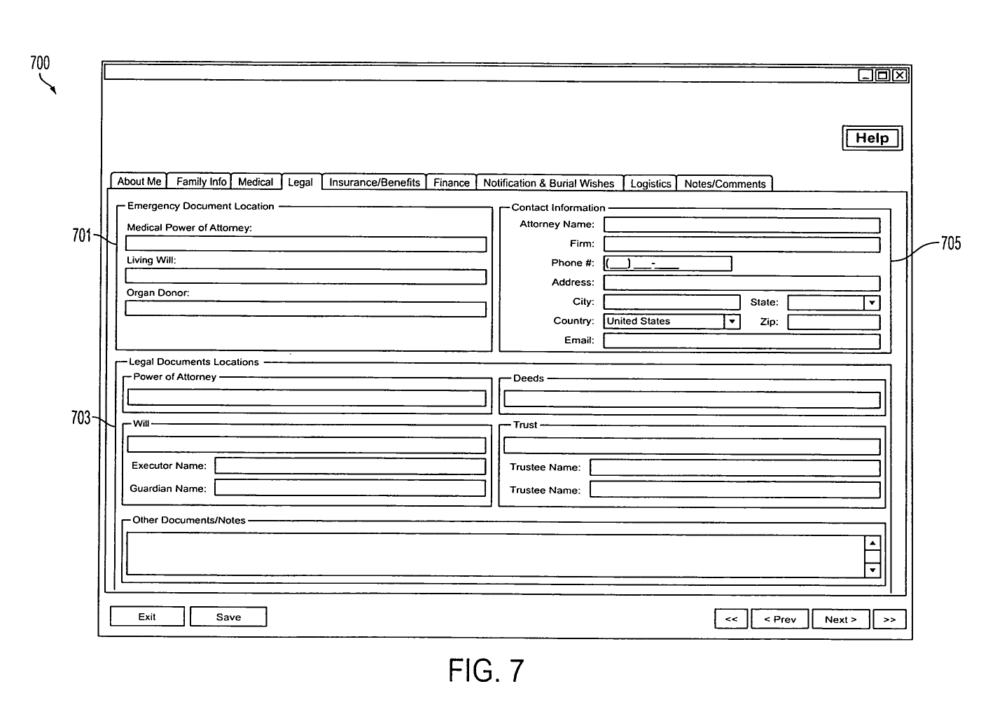

FIG. 7 illustrates an interface 700, which is an example of a form 105 enabling the receipt of legal information. Interface 700 may include a region 701 having fields, whereby information related to and a location of one or more emergency documents may be entered by the user. Interface 700 may also include an interface 703 having fields, whereby information related to and a location of one or more legal documents may be entered by the user. Interface 700 may also include a region 705 having fields, whereby information relating to one or more persons of legal relevance may be entered by the user. In some embodiments, the information from region 705 may be used to create an entry for a person of legal relevance.

In some embodiments, critical personal information provided by the user and received by application 101 may also include insurance/benefit information. Insurance/benefit information may include information relating to insurance policies held by the user or other benefit information. In some embodiments, one or more entries may be created that are associated with insurance/benefit information. In some embodiments, an entry may be associated with a description of a type of benefit, a contact person related to the benefit, an organization providing the benefit, an address of the contact person, a phone number of the contact person, a phone number for the contact person, an email address for the contact person, a narrative or portion of text, or other information. The entries may be created, saved, updated, or deleted by the user, as desired.

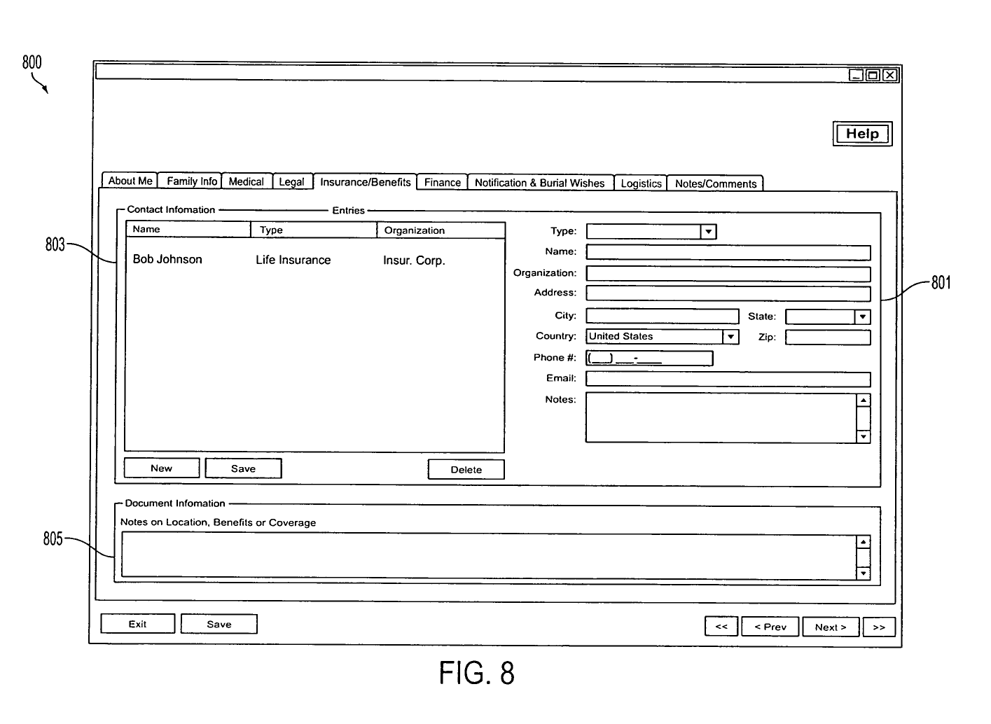

FIG. 8 illustrates an interface 800, which is an example of a form 105 enabling receipt of insurance/benefit information, including enabling creation of entries regarding individual insurance policies or benefits. Interface 800 may include a region 801 having fields, whereby information relating to persons relevant to insurance or benefits of the user may be entered and used to create entries. Interface 800 may include a region 803, wherein entries regarding persons relevant to insurance or benefits of the user and information relating to those entries (e.g., a type of insurance or benefit and an associated organization) may be listed, and selected for editing or deletion. Interface 800 may include a region 805 having fields, whereby additional information relating to insurance or benefits may be entered by the user.

In some embodiments, critical personal information received by application 101 may include financial information. Financial information may include information relating to persons of financial relevance to the user such as, for example, accountants, attorneys, estate planners, investment advisors, employers, or other persons of financial relevance. In some embodiments, one or more entries may be created, each for a separate person of financial relevance. Each entry may include information relating to a person of financial relevance such as, for example, an indicator of the type of financial relationship the person has with the user, a name of the person of financial relevance, an institution associated with the person, a phone number, an address, an email address, other contact information, notes, or other information relating to the person of financial relevance. The entries may be created, saved, updated, or deleted by user 109 as desired.

In some embodiments, financial information may include information relating to accounts, investments, or other financially related information regarding the user such as, for example, account numbers, names of institutions associated with accounts, contact information associated with accounts (phone numbers, addresses, or other contact information), notes regarding accounts, or other information, In some embodiments, entries may be created for accounts. The entries may be created, saved, updated, or deleted by the user as desired.

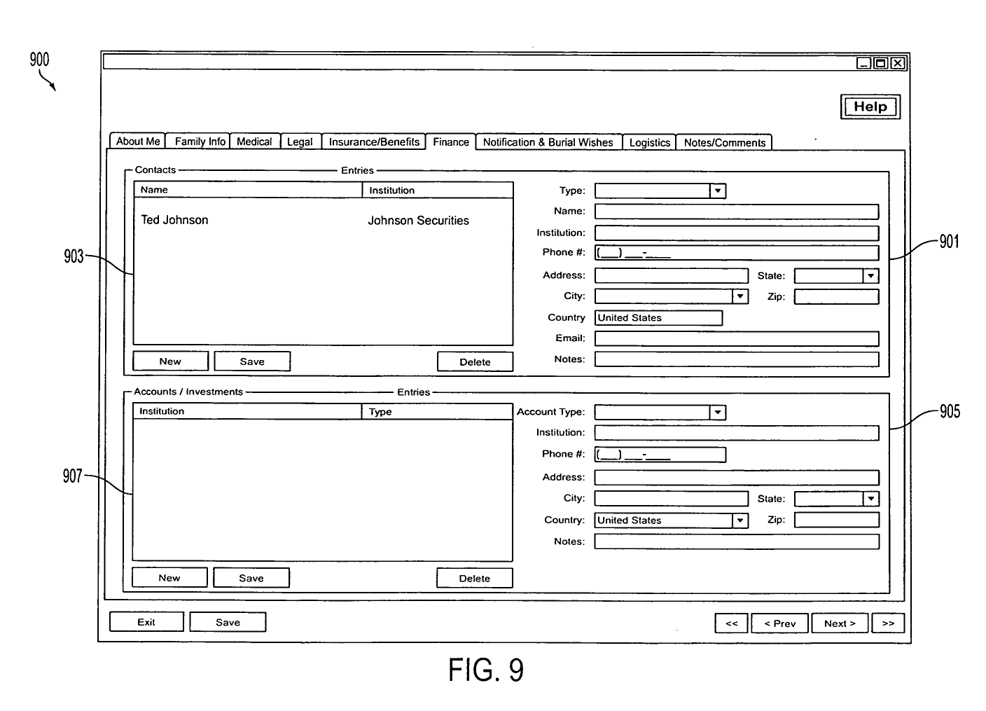

FIG. 9 illustrates an interface 900, which is an example of a form 105 enabling receipt of financial information, including enabling creation of entries regarding persons of financial relevance, accounts, investments, or other entries. Interface 900 may include a region 901 having fields, whereby information relating to persons of financial relevance may be entered by the user. Interface 900 may include a region 903, wherein entries regarding persons of financial relevance and information relating to those entries (e.g., an associated organization) may be listed, and selected for editing or deletion. Interface may include a region 905, wherein information relating to specific accounts or investments may be entered by the user. Interface 900 may also include a region 907, wherein entries relating to accounts or investments of the user and information relating to those entries (e.g., an associated organization and a type of account or investment) may be listed, and selected for editing or deletion.

In some embodiments, critical personal information received by application 101 may include end-of-life-related information. End-of-life-related information may include memorial/burial preference information, end-of-life notification information, and/or other information. Memorial/burial preference information may include a name of a funeral home or other business entity for performing end-of-life services (whether or not those services have been pre-arranged), an address for the funeral home, a phone number for the funeral home, an indication as to whether cremation or burial is preferred, a name of a cemetery where remains are to be buried (whether or not arrangements have been pre-arranged), a contract number for any previously made arrangements regarding burial with a cemetery or funeral home, a plot or vault number of any previously purchased burial plots or vaults, a location of a cemetery where remains are to be buried, a name of a clergy member or other person who is to preside over any burial ceremonies, a name of a person preferred to make statements at any burial ceremonies, names of preferred pall bearers, a narrative or portion of text explaining other memorial-related wishes, or other notes or information. In some embodiments, end-of-life notification information may include names of family, friends, and/or other persons to be notified upon death of the user, text to be included in an obituary for a deceased user, a list of publications in which the obituary of a deceased user is to be published, a list of entities (e.g., charities) to which memorial donations are to be made to, one or more organizations to be notified upon the death of the user (e.g., schools, fraternal organizations, labor unions, employers), or other information.

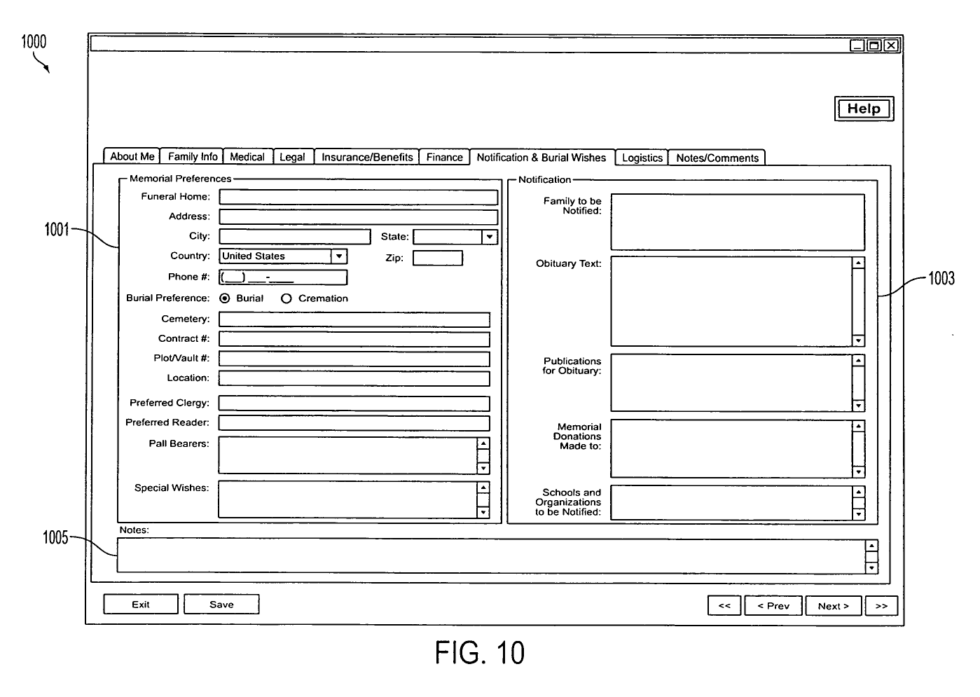

FIG. 10 illustrates an interface 1000, which is an example of a form 105 enabling receipt of end-of-life-related information. Interface 1000 may include a region 1001, whereby memorial/burial preference related information may be entered by the user. Interface 1000 may also include a region 1003, whereby end-of-life notification information may be entered by the user. Interface 1000 may include a region 1005 whereby notes regarding end-of-life information may be entered by the user.

In some embodiments, entries related to one or more listed friends/family, medically relevant persons, legally relevant persons, insurance/benefit related persons, financially relevant persons, or other persons may be used to generate a list of people to be notified upon the occurrence of an critical life event (e.g., death, incapacitation, emergency) related to the user. This list may be displayed in a region of interface 1000 or other interface of application 101 and the user may select people from the list to be notified upon occurrence of a critical life event. In some embodiments, information regarding the type of critical life event that must occur for a specific person to be notified may be specified (e.g., “notify Tom Johnson upon death only”). In some embodiments, the user may enter identifying information of people not associated with entries within application 101 who are to be notified upon the occurrence of a critical life event.

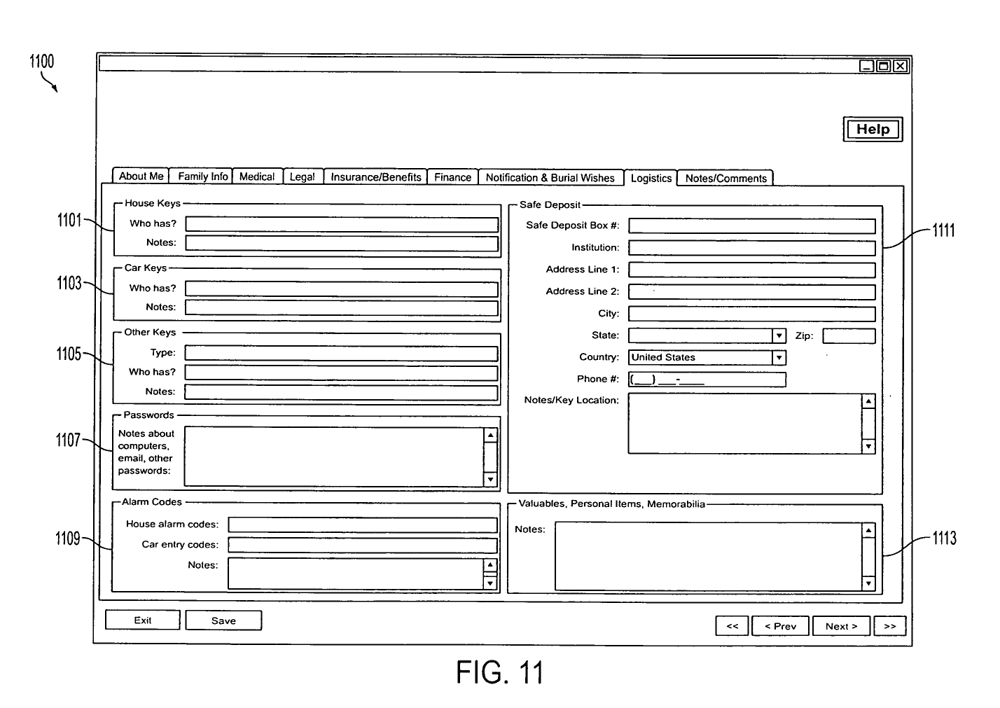

In some embodiments, critical personal information received by application 101 may include logistical information. Logistical information may include practical information relating to the user possessions or affairs such as, for example, an identity of persons possessing house keys, car keys, other keys, other information or notes relating to those keys (e.g., the type of key for “other keys” or other information). Logistical information may also include safe deposit box information such as, for example, the number of safe deposit box, the institution where the safe deposit box is located, an address for the institution, a phone number for the institution, notes related to the location of the keys for the safe deposit box, other notes related to the safe deposit box, or other information. Logistical information may also include information related to passwords and/or usernames for accounts that the user may have with websites or other entities. In some embodiments, logistical information may include information related to home alarm codes, business alarm entry codes, car entry codes, or other security system information. Logistical information may include notes or other information related to valuables, personal items, memorabilia, or other information. FIG. 11 illustrates an interface 1100, which is an example of a form 105 enabling receipt of logistical information relating to the user 109. Interface 1100 may include one or more regions (e.g., regions 1101-1113), wherein logistical information may be entered by the user.

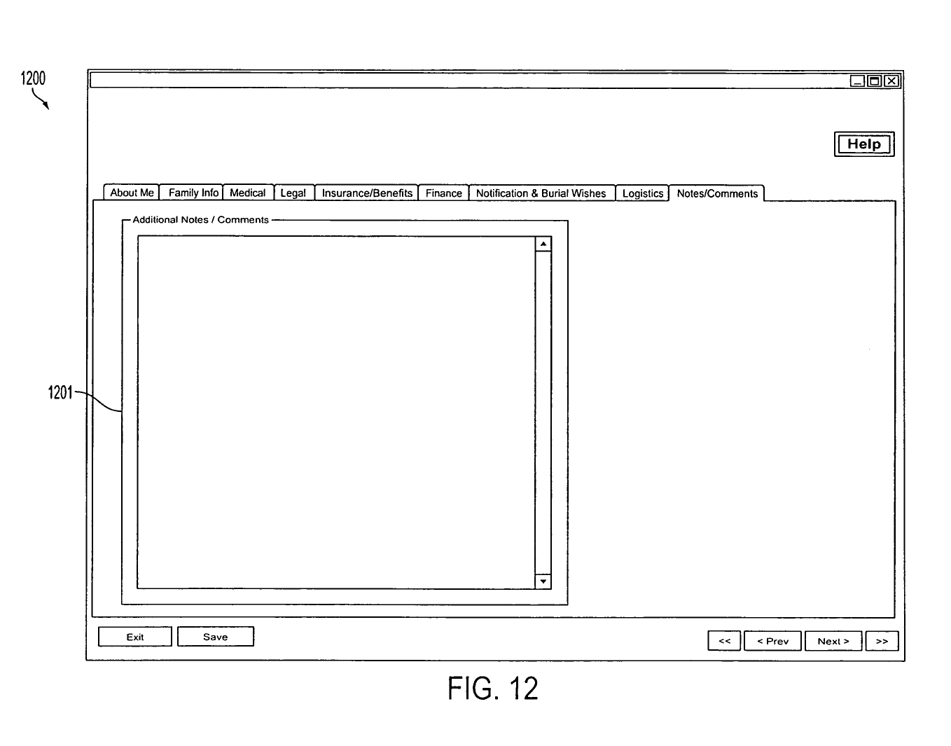

In some embodiments, critical personal information received by application 101 may also include additional notes or comments, which may be in narrative for textual format. FIG. 12 illustrates an interface 1200, which is an example of a form 105 for receiving additional notes, comments, or other critical personal information from user 109. Interface 1200 may include a region 1201, wherein textual information may be entered by the user.

In some embodiments, critical personal information for a specific user 109 may be saved to one or more specific files at any time. In some embodiments, the one or more files including the user's personal critical information may be saved locally on user computer 109. In some embodiments, the one or more files may be saved to a remote site (e.g., database 107, server 108) that is accessible by user computer 109. In some embodiments, the one or more files including the users' critical personal information may be encrypted and stored as an encrypted file so as to prevent unauthorized access to critical personal information regardless of where the one or more files are saved. In some embodiments, encrypted files may be additionally protected by a password selected by or provided to the user. The encryption and/or password protection of files including critical personal information may be directed or otherwise enabled by encryption module 103c or other module of application 101, which in some embodiments, may utilize a 256 bit standard, as described below. The one or more files including critical personal information may be edited and/or deleted by their respective users at will. In some embodiments, the file name of files including critical personal information may include one or more indicators of the identity of the specific user whose critical personal information is stored therein (e.g., johnsmith.poi). In some embodiments, a backup of the file including critical personal information may be saved by the user to any location at any time.

Referring back to process 200 of FIGS. 2A and 2B, in an operation 209, the user may designate one or more recipients to be enabled to receive and/or view certain critical personal information regarding the user stored by application 101. In some embodiments, the user may designate recipients using an interface provided by application 101. For example, in some embodiments, application 101 may present a list of “available recipients” to a user. In some embodiments, the list of available recipients may be derived from the critical personal information received by application 101. For example, whenever an entry regarding a person (family members, friends, medical personnel, persons of legal relevance, persons of financial relevance, or other people) is received by application 101 in connection with a certain user's profile, that entry may be used to derive an “available recipient” (i.e., a potential recipient) for the list of available recipients. In some embodiments, available recipients may be derived and/or received in other ways. The user may then designate recipients from listed available recipients. In some embodiments, recipients that will be enabled to receive and/or view certain critical personal information may be selected/designated in other ways.

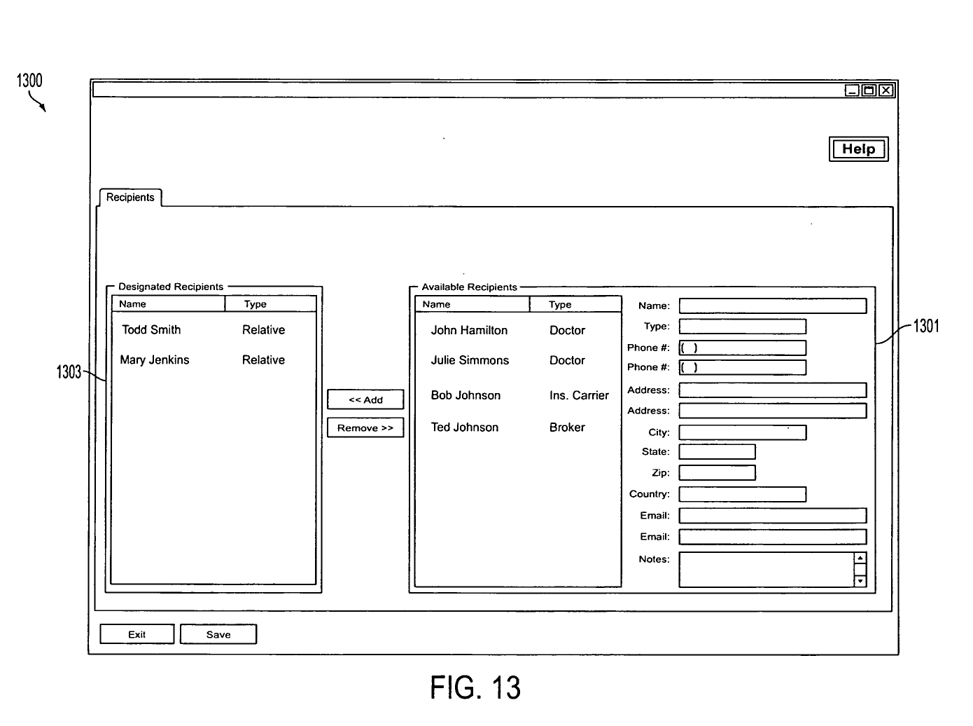

FIG. 13 illustrates an interface 1300, which is an example of an interface that displays a list of available recipients and enables users to designate/select recipients 111. Interface 1300 may include a region 1301 wherein a list of available recipients and information regarding one or more of the available recipients (e.g., name, description of relationship or relevance to the user, contact information, notes, and/or other information). The user may select or “designate” recipient from the list of available recipients in region 1301. Interface 1300 may include a region 1303 wherein designated recipients and information relating thereto (e.g., a description of the relationship or relevance to the user) are listed. As illustrated in FIG. 13, when a recipient is selected from the list of available recipients, the recipient is thereafter listed on the list of designated recipients, but not the list of available recipients.

In an operation 211, for a selected/designated recipient, the user may prepare the designated recipient's file or otherwise specify the critical personal information that will be made available to the designated recipient. In some embodiments, the user may be presented with a list of critical personal information types (e.g., friend/family information, medical information, legal information, financial information, insurance/benefits information, end-of-life-related information, logistical information, notes, or other information) from which to choose, wherein information of a chosen type that is associated with the user's profile is sent or otherwise made available to the designated recipient. In some embodiments, the critical personal information to be made accessible to a particular recipient may be designated on an item-by-item basis such that within different categories of information, some items of information may be selected for accessibility by a particular recipient, while others may be selected (actively or passively) so as to be inaccessible by the recipient. In this manner, the user may distribute or otherwise provide access to different sets of information to different recipients using a single master data set.

For example, the user may indicate that a spouse is to receive or be granted access to all critical personal information regarding the user stored the application 101. The user may indicate that a neighbor is only to receive or be granted access to certain items of logistical information (e.g., house keys and alarm codes but not safe deposit box information). Finally, the user may indicate that a doctor is to be granted access to medical information only. Other selective sets of information may be designated for other recipients. Other methods of selecting subsets of critical personal information for distribution to recipients may be used.

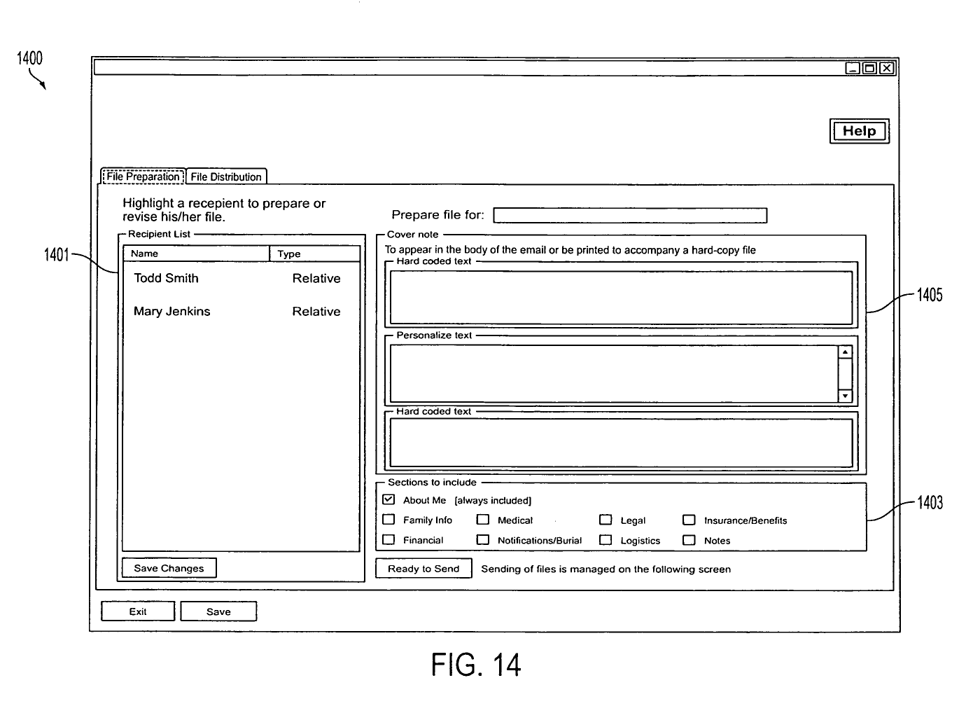

FIG. 14 illustrates an interface 1400, which is an example of an interface that enables selection of a designated recipient for which selected certain personal critical information to be distributed to the selected designated recipient, selection of certain critical personal information types for distribution to recipients, and construction of a message to accompany sent personal critical information. Interface may include a region 1401, which may include a list of designated recipients and information regarding the listed recipients (e.g., a description of the relationship or relevance to the user). The user may select a designated recipient from the list and prepare the set of personal critical information to be sent to the selected designated recipient. Interface 1400 includes a region 1403, which illustrates an example wherein each of one or more critical personal information “types” may be associated with a check-box. When the user checks the check box for a particular critical personal information type, the critical personal information of that type may be included in the critical personal information distributed to the selected designated recipient. As indicated above, other methods or information selection schemes may be used to select critical personal information for distribution to designated recipients. As discussed herein, in some embodiments, the user may select specific critical personal information from within categories/types of critical personal information to be provided to a recipient on an item-by-item basis (e.g., not all critical personal information from a category/type need be provided to the recipient).

In some embodiments, distribution of critical personal information to recipients may include sending an email, document, or other communication to recipients. As such, in in an operation 212, the user 109 may provide application 101 with specific and/or personalized text to be included in the email, document, or other communication to a recipient. Interface 1400 may include a region 1405, which illustrates an example wherein a message may be sent to a recipient along with access to the user's personal critical information. Region 1405 may display standardized hardcoded text provided by, for example, a service provider, which offers recipients an introductory explanation of what they have received. In some embodiments, this standardized text may be inserted by application 101 in hardcoded form into the communication. In some embodiments, region 1405 may enable the user to compose and include personalized text in a message to a recipient in order to demonstrate that the outbound communication was prepared for and transmitted to the recipient individually (as opposed to a mass distribution or a marketing/sales communication) or for other purposes.

In an operation 213, an outbound communication may be sent to a designated recipient. Communication module 103d or other module of application 101 may enable the outbound communication to be sent. In some embodiments, the outbound communication may include the critical personal information selected for the designated recipient. For example, the designated recipient may be sent an email that includes an encrypted file 119 (see FIG. 1) having the selected critical personal information therein. An encryption module 103c or other module of application 101 may encrypt the selected critical personal information in encrypted file 119. In some embodiments, encryption module 103c may utilize 256 bit encryption. In some embodiments, encryption module 103c may utilize the Rijndael Symmetric Algorithm for 256 bit encryption (SHA256→http:\\en.wikipedia.org\wiki\SHA-1). In some embodiments, encryption module 103c may utilize 128 bit encryption and/or other encryption schemes. In some embodiments, encryption module 103c may embed a “salt” key in the body of encrypted file 119 so that the document can only be opened by a specific viewer (e.g., viewer 121).

In some embodiments, the outbound communication may only be able to be sent upon completion of a minimum amount of information necessary for the communication to be sent (e.g., at least some critical personal information, including contact information necessary to send the outbound communication to the designated recipient). In some embodiments, the minimum amount of information may be dictated by rules module 103d. In some embodiments, the outbound communication may only be sent upon the user explicitly indicating that the communication be sent (e.g., by clicking a “send” button on an interface supported by application 101). As such, in some embodiments, the outbound communication may be sent at the will of the user. Thus, application 101 enables the user to send to recipient, and recipients to access, critical personal information prior to the occurrence of the death or incapacitation or occurrence of an other critical life event relating to the user. Furthermore, subsequent communications updating the critical personal information sent to recipients may be sent at the will of the user.

In some embodiments, the user may designate a person (e.g., a family member, attorney, or other person) who monitors for the occurrence of the event and who is given access to the user's profile (access that is the equal or nearly equal to that of the user) such that the designated person can designate recipients and send the outbound communication to designated recipients.

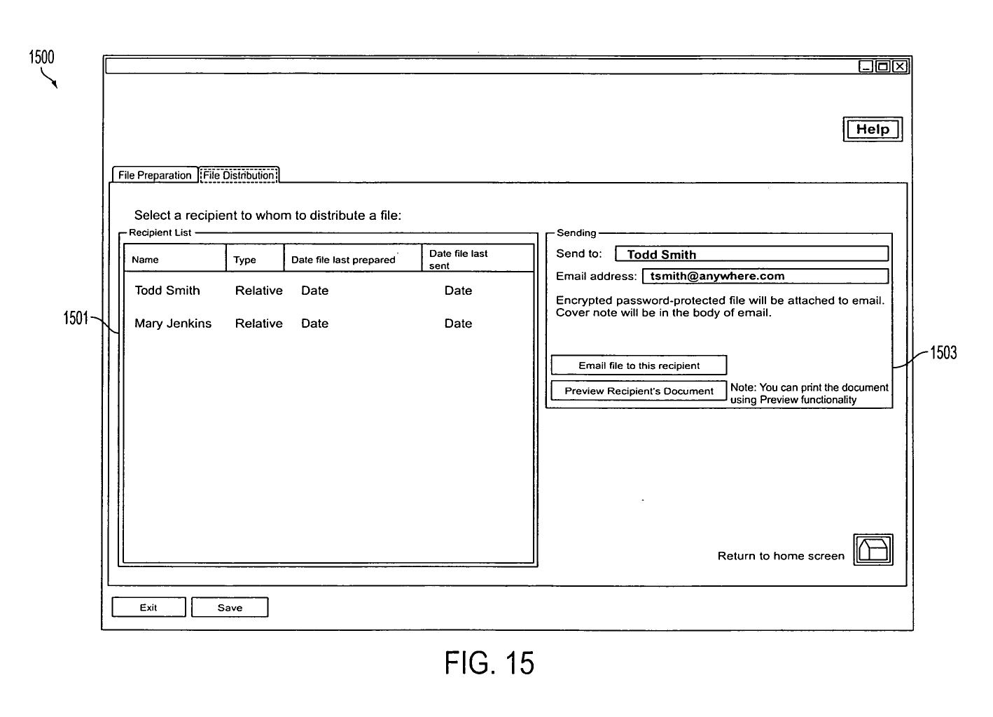

FIG. 15 illustrates an interface 1500, which is an example of an interface wherein a user may preview, print, and/or initiate sending of an email communication to a designated recipient that includes an encrypted file 119. Interface 1500 may include a region 1501, wherein designated recipients and information relating thereto (e.g., a description of the relationship or relevance to the user, a date a file including personal critical information of the user was prepared, a date a file including personal critical information of the user was sent to a user, or other information) are listed. The user may select a designated recipient from the list and indicate that a file including the selected portions of the user's personal critical information is to be sent to the selected designated recipient.

Interface 1500 may enable the user to preview the set of critical personal information that will be sent to a selected designated recipient. For example, a region 1503 of interface 1500 may enable the user to indicate that he or she desires to preview the critical personal information that will be sent to a selected designated recipient by clicking on a button (e.g., “Preview Recipient's Document”) of region 1503 or interface 1500. The user may then be presented with a document that includes the critical personal information selected for presentation to the selected designated recipient and/or any message that will be sent with or part of the outbound communication.

Interface 1500 may enable a user to indicate that the file including the selected portions of the user's personal critical information is to be sent in an outbound communication. For example, the user may indicate that he or she desires to send the outbound communication to a selected designated recipient clicking a button (e.g., “email file to this recipient”) or other indicator of region 1053 or interface 1500. In some embodiments, application 101 may interact with a local email application (e.g., Microsoft Outlook™ or other email application) on user computer 109 to present the user with a draft email to the selected designated recipient, which may include the critical personal information selected to be sent to the selected designated recipient. As described herein, in some embodiments, the selected critical personal information may be in the form of an encrypted file attached to the draft email. In some embodiments, the draft email may include text describing what the purpose of the email is and/or other information. For example, in some embodiments, the email may include any standardized hardcoded and/or custom text from interface 1400. The hardcoded text may explain the purpose of the email or provide other information, and the custom text may serve to provide custom information to the recipient and otherwise indicate that the email is not a solicitation or spam. When the user is satisfied that the email is sufficient, the user may click send on the presented email (or otherwise send the email using the local email application's methodology) upon which the local email application may send the email to the selected designated recipient.

In some embodiments, the outbound communication may be sent to a designated recipient using an email address stored in an “entry” created for the designated recipient. In some embodiments, the entry may be part of the critical personal information provided to application 101 by the user. In some embodiments, the user may provide the email address or other information pertaining to transmittal of the outbound communication to the designated recipient after the user has provided critical personal information to application 101. Region 1503 of interface 1500, may display a selected designated recipient's email address or other contact information, such that the user may confirm and/or correct the information.

While interface 1500 is presented after interface 1400, a user may encounter these interfaces and any interfaces of the invention in different orders than reflected by the ordering of the figures.

In some embodiments, the outbound communication need not be an email but may take the form of a fax, traditional letter, or other form. In some embodiments, the user or a service provider providing access to the systems and methods of the invention may send a recipient a communication wherein the selected critical personal information is included in non-encrypted form such as, for example, a fax, email, a traditional letter (e.g. letter 117 of FIG. 1), or other communication.

In some embodiments, the outbound communication may not include any of the selected critical personal information but may include instructions and/or other information enabling a recipient to access the selected critical personal information from a remote site (e.g., the selected personal critical information may be stored on database 107 and may be accessible via server 108 and network 113). In some embodiments, wherein the selected critical personal information is stored on the remote site, the recipient may view the selected critical personal information via a graphical user interface provided by the remote site (e.g., server 108). When the selected personal critical information is accessible in this manner, the instructions and/or other information sent to the recipient in the outbound communication may include a web address for the remote site, a username, a password, and/or other information enabling the user to the access the remote site, identify the user profile of the user who designated the recipient, and view the selected critical personal information stored on the remote site.

If, in an operation 215 (see FIG. 2B), the outbound communication includes critical personal information that is not encrypted in some form (e.g., a letter sent by traditional mail or a fax that includes critical personal information), a recipient may view the critical personal information in an operation 217.

If the outbound communication includes critical personal information that is encrypted, (e.g., an encrypted file 119 attached to an email or otherwise transmitted to recipient computer 111), the recipient requires a viewer 121 (see FIG. 1) to view, save, and/or otherwise access the encrypted personal critical information. In an operation 219, if the recipient has viewer 121 on his or her recipient computer 111, the recipient may utilize viewer 121 to view, save, password protect, or otherwise access the personal critical information sent by the user in an operation 221.

If in operation 219, the recipient does not have viewer 121, the recipient may obtain viewer 121 in an operation 223. Viewer 121 may be obtained in may ways. For example, in some embodiments, the recipient may access a remote site (e.g., server 108, via network 113) operated by or on behalf of a service provider providing access to the systems and methods of the invention to download a copy of viewer 121. In some embodiments, viewer 121 may not be available elsewhere. In some embodiments, the recipient may receive instructions (e.g. a web address and/or password) for accessing the remote site downloading viewer 121. In some embodiments, the instructions may be sent in the outbound communication with the encrypted file 119. In some embodiments, a password enabling the recipient to download viewer 121 may be received in a separate communication, which may be initiated by the user, the operator of the remote site (a service provider), or other entity. In some embodiments, the recipient may have received instructions (including a password) for downloading viewer 121 prior to, after, or concurrent with receiving the outbound communication that includes encrypted file 119. In some embodiments, the recipient may receive instructions for downloading viewer 121 via email (e.g., to recipient computer 111 or other computer), telephone call, fax, traditional mail, or other communication. In some embodiments, the user may determine the timing of sending instructions (including passwords) for downloading viewer 121 to a recipient.

In some embodiments, the recipient need not access the remote site to obtain viewer 121, but may obtain viewer 121 by other methods (e.g., via email, via a disk or other memory device mailed to recipient via traditional mail, or by other methods).

In some embodiments, viewer 121 may be a version of application 101 and/or one or more of modules 103a-103n. However, in some embodiments, one or more features of application 101 may be disabled when used by a recipient as viewer 121. For example, the recipient may only be able to use viewer 121 to view the critical encrypted personal information of the user, saving this critical personal information (e.g., locally to recipient computer 111), encrypting this critical personal information, password protecting this critical personal information, and/or other functions. The other functions of application 101 (e.g., creating a new profile, editing critical personal information, designating recipients, providing recipients access to critical personal information, and/or other functions of application 101) may be disabled, but may be enabled upon the recipient obtaining a license to the functionality of application 101. The license may be obtained from a service provider providing access to the systems and methods of the invention or (e.g., the recipient may pay a fee and/or otherwise obtain a license to the functionality of application 101 and thereby may become a “user” of application 101). The recipient may interact with the service provider via 113 (e.g., the recipient may access a website of the service provider supported by server 108). By utilizing a partially-disabled version of application 101 as viewer 121, a separate viewer need not be created for distribution of critical personal information.

Additionally, use of a viewer that is a partially-disabled version of application 101, which can be made fully functional upon receipt of a license enables “viral” marketing of application 101. For example, a recipient may receive access to user's critical personal information and may download viewer 121 (which may be a partially disabled version of application 101). The recipient may then receive a communication that notifies the recipient that they may become a user and as such utilize the remaining functionality of application 101 upon obtaining a license thereto. As more recipients obtain licenses, the application may be sent to more and more individuals who, in turn, may become licensees.

In some embodiments, upon obtaining a license to application 101, recipients may be able to create new user profiles for themselves (or if, for example, the recipient is a professional, the recipient may create new user profiles for clients), but may only be able to view, save, and/or protect the critical personal critical information sent to them by other users (i.e., the recipient could not edit the personal critical information sent by users).

Once the recipient obtains viewer 121 in operation 223, the recipient may access the encrypted personal critical information in operation 221 In an operation 221, selected recipient 111 may utilize viewer 121 to view, save, encrypt, and/or password protect the critical personal information of the encrypted file sent in the communication of operation 213.

In an operation 225 (see FIG. 2A), the user may update the critical personal information associated with their user profile and may send communications to selected recipients enabling selected recipients to view the updated critical personal information (e.g., via an updated encrypted file).

As described herein, in some embodiments, the outbound communication sent to selected the recipient in operation 213 may not include the selected critical personal information, but may include instructions as to how to access a remote site and view the selected critical personal information. As such, the recipient may access the remote site (e.g., access server 108 via network 113) and view the selected critical personal information (e.g., via a website provided by server 108). In some embodiments, the selected critical personal information stored on the remote site may be encrypted.

In some embodiments, a professional or person who is selected as a recipient for multiple users (e.g., doctor, attorney, or other person) may have multiple encrypted files 119 stored on their recipient computer 111, each encrypted file 119 having a different user is set of critical personal information thereon. In some embodiments, the critical personal information on each of the encrypted files may be viewed, saved, encrypted, password protected or otherwise accessed by a single viewer 121, which, in some embodiments, may be a version of application 101. In some embodiments, the recipient having multiple user profiles stored on their computer system may view a list of the stored user profiles on an interface provided by viewer 121 (see, for example, the list of profiles of interface 400 of FIG. 4). The recipient may then chose a user profile with which to interact. In some embodiments, the recipient may browse through tabbed interfaces displaying different types of critical personal information similar to the scheme represented in interfaces 500-1200 of FIGS. 5-12. However, the tabbed interfaces may only display information specifically selected by the user whose personal critical information is being used for access by the recipient and may not allow editing of the information.

In some embodiments, different viewers 121, each specific to an encrypted file, may be required to view, save, encrypt, password protect or otherwise access the different critical personal information. In some embodiments, a professional or person who is selected as a recipient 111 for multiple users may access the critical personal information of the multiple users via a remote site (e.g. at database 107/server 108 via network 113).

In some embodiments, a service provider who distributes application 101 licenses thereto or an entity having a relationship with such a service provider may utilize pre-existing knowledge that the service provider or entity has of a user to pre-populate one or more fields of forms 105 such that the user need not provide that information to application 101. For example, a financial services organization may utilize information the organization has regarding its customers to distribute copies of application 101 with the customer's accounts and contacts with the financial services organization pre-populated. In another example, a union or insurance provider may distribute copies of application 101 to its members/customers with benefits information pre-populated for each member customer.

One having ordinary skill in the art will recognize that various operations of the processes and methods described herein may be performed in an order other than the order listed herein. In some embodiments, additional operations may be performed. In some embodiments, not all operations may be necessary.

In some embodiments, application 101 provides an index for becoming aware of and locating critical documents things, accounts, people, and/or other critical personal information that may be useful to others during a critical life event or may otherwise be useful to the user or others. The system of the invention need not actually store critical documents, but may store and provide access to data relating to those documents (e.g., location, names of executors, beneficiaries or other data) and may store and provide access to other critical personal information.

In some embodiments, encrypted file 119 sent to recipients includes only the critical personal information selected for access by the recipient and viewer 121 enables the recipient to access all of the critical personal information in the encrypted file 119. In some embodiments, however, the encrypted file 119 may include some critical personal information not selected for access by the designated recipient. In these embodiments, viewer 121 may only enable the designated recipient access to the critical personal information selected specifically by the user for access by the designated recipient. For example in some embodiments, access rights that dictate what critical personal information is to be accessed by which recipients may be associated with the encrypted file 119, with viewer 121, or may be found elsewhere. These access rights may instruct viewer 121 to limit access to the personal critical information in the encrypted file 119.

In some embodiments, the invention may include a computer readable medium having thereon computer readable code for instructing one or more processors to perform one or more of the features and functions of invention described herein. For example, the computer readable code may instruct one or more processors to receive and store user account information, select from existing user accounts, receive critical personal information, receive recipient-related information, select recipients, prepare recipient files, send outbound communications to recipients, enable recipients to obtain viewer 121, and/or enable other features or functions described herein.

While the invention has been described with reference to the certain illustrated embodiments, the words that have been used herein are words of description, rather than words of limitation. Changes may be made, within the purview of the associated claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

What is claimed is:

1. A method for aggregating and selectively distributing critical personal information for use during or after a critical life event, the method comprising:
receiving critical personal information regarding a user;
receiving contact information regarding at least one recipient;
receiving instructions to send at least part of the critical personal information to the at least one recipient;
creating at least one encrypted file comprising the at least part of the critical personal information;
transmitting the at least one encrypted file to the at least one recipient using the contact information regarding the at least one recipient; and
transmitting a viewer module to the at least one recipient, wherein the viewer module enables the at least one recipient to view the at least part of the critical personal information comprising the at least one encrypted file from a computer-implemented device of the at least one recipient.

2. The method of claim 1, wherein the viewer module comprises an computer-implemented application having functions that enable the at least one recipient to aggregate and selectively distribute critical personal information regarding the at least one recipient upon obtaining a license for the computer-implemented application.

3. The method of claim 1, wherein the critical personal information includes information regarding a location of one or more legally significant documents that are relevant after a user has become deceased or incapacitated.

4. The method of claim 1, wherein receiving contact information regarding at least one recipient comprises receiving contact information regarding at least a first recipient and a second recipient, and
wherein receiving instructions to send at least part of the critical personal information to the at least one recipient comprises receiving instructions to send a first set of critical personal information to the first recipient and a second set of critical personal information to the second recipient.

5. The method of claim 1, wherein the received critical personal information is organized into two or more categories, and wherein receiving instructions to send at least part of the critical personal information to the at least one recipient includes receiving a selection of at least one of the two or more categories.

6. The method of claim 1, wherein the received critical personal information comprises a plurality of items of critical personal information, and wherein receiving instructions to send at least part of the critical personal information to the at least one recipient includes receiving a selection of at least one of the plurality of items of critical personal information.

7. The method of claim 1, wherein receiving the critical personal information further comprises receiving the critical personal information at a user computer, wherein creating the at least one encrypted file further comprises creating the at least one encrypted file at the user computer, and wherein transmitting the at least one encrypted file to the at least one recipient further comprises transmitting the at least one encrypted file from the user computer to a recipient computer.

8. The method of claim 7, wherein transmitting the viewer module to the at least one recipient further comprises transmitting the viewer module to the at least one recipient from a computer remote from the user computer that is operated by a service provider.

9. The method of claim 1, wherein the received critical personal information includes contact information regarding one or more persons, wherein receiving contact information regarding at least one recipient further comprises:
providing a listing of the one or more persons, and
receiving a selection of at least one of the one of the one or more persons as the at least one recipient.

10. A system for aggregating and selectively distributing critical personal information for use during or after a critical life event, comprising:
an computer application including:
a data reception module that receives, via one or more graphical user interfaces, critical personal information regarding a user, contact information regarding at least one recipient, and instructions to send at least part of the critical personal information to the at least one recipient,
an encryption module that creates at least one encrypted file comprising the at least part of the critical personal information, and
a communication module that transmits the at least one encrypted file to the at least one recipient; and
a viewer module that enables the at least one recipient to view the at least part of the critical personal information comprising the at least one encrypted file from a computer of the at least one recipient.

11. The system of claim 10, wherein the viewer module comprises a copy of the computer application that enables the at least one recipient to aggregate and selectively distribute critical personal information regarding the at least one recipient.

12. The system of claim 11, wherein features of the viewer module enabling the at least one recipient to aggregate and selectively distribute critical personal information regarding the at least one recipient are enabled only when the at least one recipient obtains a license to the copy of the computer-implemented application.

13. The system of claim 10, wherein the contact information regarding at least one recipient comprises contact information regarding at least a first recipient and a second recipient, and
wherein the instructions to send at least part of the critical personal information to the at least one recipient comprises instructions to send a first set of critical personal information to the first recipient and a second set of critical personal information to the second recipient.

14. The system of claim 10, wherein the received critical personal information is organized into two or more categories, and wherein the instructions to send at least part of the critical personal information to the at least one recipient includes a selection of at least one of the two or more categories.

15. The system of claim 10, wherein the received critical personal information comprises a plurality of items of critical personal information, and wherein the instructions to send at least part of the critical personal information to the at least one recipient includes a selection of at least one of the plurality of items of critical personal information.

16. The system of claim 10, the computer application resides on a user computer, and wherein the at least one encrypted file is transmitted to the at least one recipient further from the user computer to the computer of the at least one recipient.

17. The system of claim 16, wherein the viewer module is transmitted to the at least one recipient from a computer remote from the user computer, the computer remote from the user computer being operated by a service provider.

18. The system of claim 10, wherein the received critical personal information includes contact information regarding one or more persons, wherein the data reception module provides a listing of the one or more persons and receives a selection of at least one of the one of the one or more persons as the at least one recipient.
